(19) United States
(12) Patent Application Publication
(10) Pub. No.: US 2015/0308345 A1
(43) Pub. Date: Oct. 29, 2015

(54) FUEL NOZZLE ASSEMBLY

(71) Applicant: General Electric Company, Schenectady, NY (US)

(72) Inventors: Stacy Ann Holzman, Simpsonville, SC (US); Michael Christopher Gibson, Duncan, SC (US); Dereck Joseph Ouellet, Cincinnati, OH (US); Bryan Wesley Romig, Simpsonville, SC (US); Jason Thurman Stewart, Greer, SC (US)

(73) Assignee: General Electric Company, Schenectady, NY (US)

(21) Appl. No.: 14/261,464

(22) Filed: Apr. 25, 2014

(51) Int. Cl. F02C 7/22; F23R 3/28

(52) U.S. Cl. CPC F02C 7/222; F23R 3/28

(57) ABSTRACT

A fuel nozzle assembly having an inlet region of a fuel nozzle base assembly that provides more uniform flow of fuel within the fuel nozzle assembly. The embodiments described herein provide fuel flow conditioning components that manage fuel uniformity within a fuel annulus and make more efficient use of allocated space, thereby overcoming spatial constraints imposed on the overall fuel nozzle assembly.

### BACKGROUND OF THE INVENTION

The subject matter disclosed herein relates to fuel nozzle assemblies and, more particularly, to aspects related to fuel flow characteristics at inlet portions of such assemblies.

Fuel nozzle assemblies are often prone to non-uniform flow at or near inlet regions of the assemblies. Often, a single inlet port is provided to route fuel to an annular arrangement within the fuel nozzle assembly. Due to smoothly contoured inner walls of the fuel nozzle assembly, high velocity jets persist at fuel injection holes within the fuel nozzle assembly and results in a varying static pressure field and mass distribution therein. This allows some of the fuel injection holes to undesirably receive much more fuel than others, thereby causing a large amount of circumferential variation around the annular arrangement.

### BRIEF DESCRIPTION OF THE INVENTION

According to one aspect of the invention, a fuel nozzle assembly includes an end cover configured to receive a fuel. Also included is a fuel channel defined by the end cover and configured to route the fuel through a portion of the end cover. Further included is a fuel nozzle base assembly having a fuel nozzle inlet region, the fuel nozzle base assembly being located adjacent to, and operatively coupled to, the end cover. Yet further included is an orifice plate disposed between the end cover and the fuel nozzle base assembly, the orifice plate having a plurality of apertures extending therethrough. Also included is an annular fuel plenum at least partially defined by the end cover and the orifice plate.

According to another aspect of the invention, a fuel nozzle assembly includes a fuel nozzle base assembly having a main fuel inlet. Also included is a fuel manifold at least partially defined by the fuel nozzle base assembly, the fuel manifold configured to receive the fuel provided through the main fuel inlet. Further included is a plurality of fuel passages circumferentially spaced from each other and extending from the fuel manifold to a fuel annulus.

According to yet another aspect of the invention, a fuel nozzle assembly includes a fuel nozzle base assembly configured to receive a fuel therein. Also included is a fuel annulus defined at an upstream end of the fuel nozzle base assembly. Further included is a pre-orifice structure directly coupled to the fuel nozzle base assembly and configured to route the fuel to the fuel annulus therein.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a perspective view of an inlet region of a fuel nozzle assembly according to a first embodiment;

FIG. 3 is a perspective view of the inlet region from a first side of an orifice plate of the fuel nozzle assembly of the embodiment of FIG. 2;

FIG. 4 is a perspective view of the inlet region from a second side of the orifice plate of the fuel nozzle assembly of the embodiment of FIG. 2;

FIG. 5 is a perspective view of a fuel nozzle assembly according to a second embodiment;

FIG. 6 is a perspective view of the fuel nozzle assembly of the embodiment of FIG. 5 with a cover plate removed;

FIG. 7 is a side elevation, partially transparent, view of the fuel nozzle assembly of the embodiment of FIG. 5;

FIG. 8 is a perspective view of a fuel nozzle assembly according to a third embodiment; and

FIG. 9 is an end view of the fuel nozzle assembly according to the embodiment of FIG. 8.

The detailed description explains embodiments of the invention, together with advantages and features, by way of example with reference to the drawings.

### DETAILED DESCRIPTION OF THE INVENTION

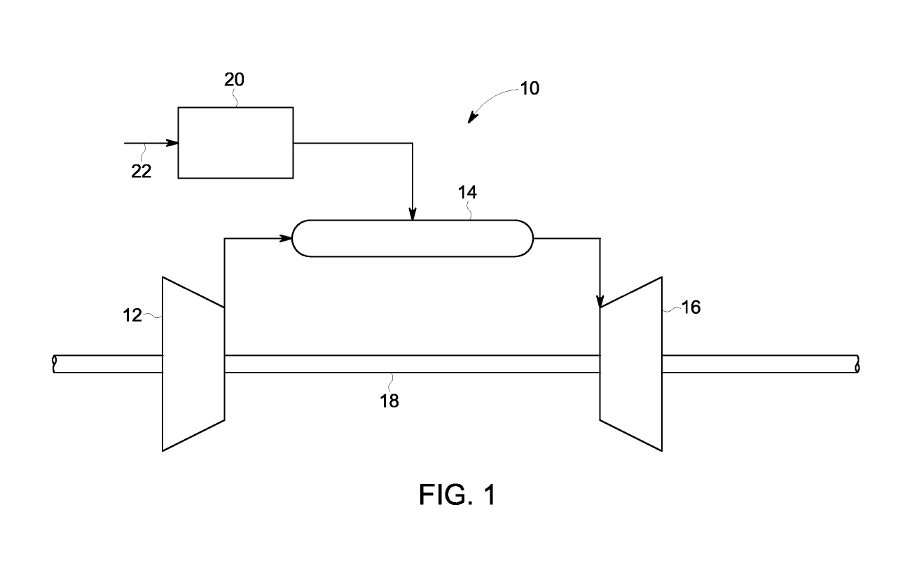

Referring to FIG. 1, a gas turbine engine 10, constructed in accordance with an exemplary embodiment of the invention, is schematically illustrated. The gas turbine engine 10 includes a compressor section 12, a combustion assembly 14, a turbine section 16, a shaft 18 and a fuel supply system 20 (also referred to herein as a fuel nozzle assembly). It is to be appreciated that one embodiment of the gas turbine engine 10 may include a plurality of compressor sections 12, combustion assemblies 14, turbine sections 16, and/or shafts 18. The compressor section 12 and the turbine section 16 are coupled by the shaft 18. The shaft 18 may be a single shaft or a plurality of shaft segments coupled together to form the shaft 18.

In operation, air flows into the compressor section 12 and is compressed into a high pressure fluid. The high pressure gas is supplied to the combustion assembly 14 and mixed with a fuel 22, for example process gas and/or synthetic gas (syngas). Alternatively, the combustion assembly 14 can combust fuels that include, but are not limited to natural gas and/or fuel oil. This invention may be applied to a gas turbine engine 10 configured to operate on both gas and liquid fuels, however, the embodiments described herein are typically associated with gas fuel passages. The fuel/air or combustible mixture is ignited to form a high pressure, high temperature combustion gas stream. Thereafter, the combustion assembly 14 channels the combustion gas stream to the turbine section 16, which converts thermal energy to mechanical, rotational energy.

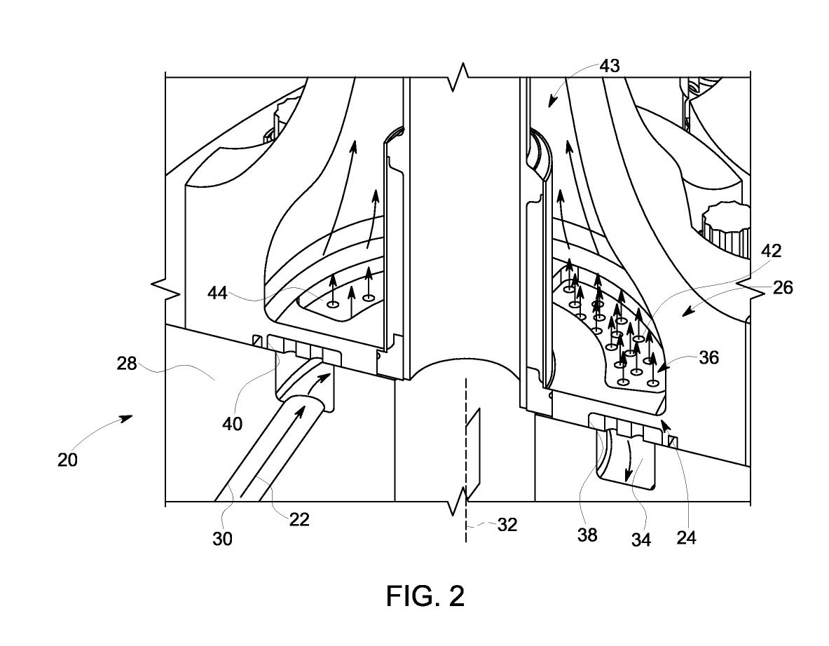

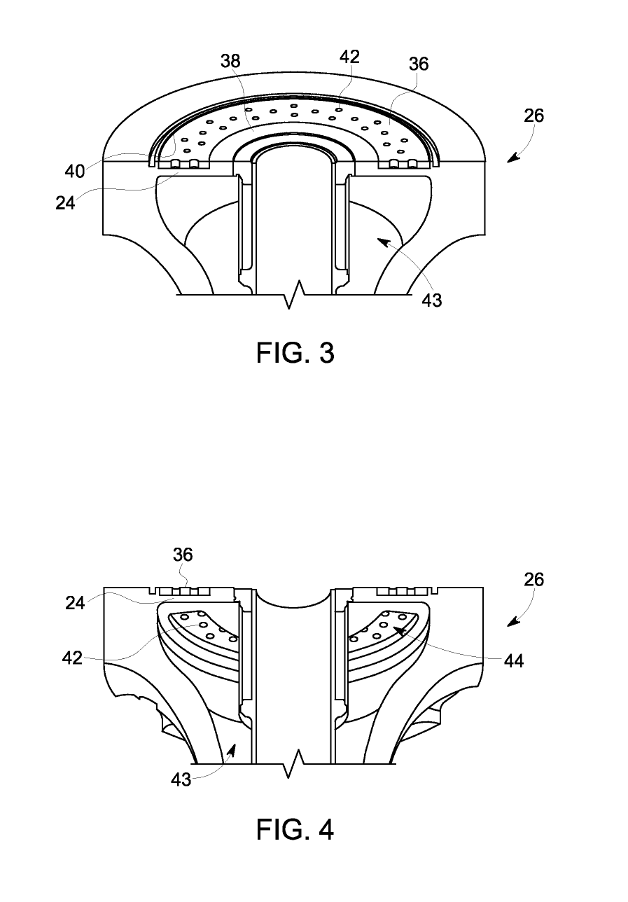

Referring now to FIGS. 2-4, the fuel supply system 20 configured to route the fuel 22 to the combustion assembly 14 is illustrated in greater detail according to an embodiment of the invention. More specifically, an inlet region 24 of the fuel supply system 20 is depicted. The inlet region 24 generally refers to a region where the fuel 22 is introduced into a fuel nozzle base assembly 26 for routing to a downstream region (not illustrated) that is configured for mixing of the fuel 22 and the high pressure gas (e.g., compressed air) referred to above. Air-fuel mixing efficiency is impacted by the flow uniformity of the fuel 22 that is introduced into the fuel nozzle base assembly 26. As such, the inlet region 24 design is an important factor in flow uniformity and, therefore, overall system performance, operability, and efficiency.

An end cover 28 is operatively coupled to one or multiple fuel nozzle base assemblies 26 proximate the inlet region 24, however a single fuel nozzle base assembly 26 is shown herein. The coupling may be made with mechanical fasteners, welding, or any other suitable joining method. The end cover 28 includes a fuel channel 30 defined therein that is configured to route the fuel 22 through the end cover 28. In the illustrated embodiment, the fuel channel 30 is oriented at a non-parallel angle to that of the axis 32, however, it is contemplated that parallel arrangements may be employed. Additionally, although a single fuel channel 30 is shown, multiple fuel channels may be provided and oriented at similar or distinct angles relative to the axis 32.

The fuel channel 30 routes the fuel 22 to an annular plenum 34 formed in the end cover 28 at a location of the end cover 28 that is immediately adjacent the inlet region of the fuel nozzle base assembly 26. The annular plenum 34 extends circumferentially about the axis 32, typically 360 degrees about the axis 32. It is to be appreciated that the precise geometric dimensions, such as width and depth, of the annular plenum 34 can vary depending on the application. Additionally, the annular plenum 34 may be relocated to fuel nozzle base assembly 26, within the same constraints and geometric opportunities listed above.

An orifice plate 36 is secured to the inlet region 24 of the fuel nozzle base assembly 26 within a recess that is defined by an inner flange 38 and an outer flange 40 of the fuel nozzle base assembly 26. This orifice plate 36 may be in addition to or in place of an orifice plug that is traditionally included within the fuel channel 30. In one embodiment, the orifice plate 36 is welded to the inner flange 38 and the outer flange 40, but it is to be appreciated that other methods of securing the orifice plate 36 may be employed, such as by brazing or mechanically fastening. Furthermore, the orifice plate 36 may additionally be secured to the end cover 28 by at least one of the securing methods described above. As illustrated, the orifice plate 36 is located to be in substantial alignment with the annular plenum 34 to facilitate fuel flow from the annular plenum 34 to the fuel nozzle base assembly 26. The orifice plate 36 includes a plurality of apertures 42 extending therethrough. The plurality of apertures 42 may be arranged in any formation and angle to axis 32 that provides desirable flow characteristics of the fuel 22. For example, the plurality of apertures 42 may be clustered or biased as generally illustrated, or may be evenly spaced, or may be angled to induce swirl within fuel 22 flows. Typically, with a 360 degree annular plenum, the plurality of apertures 42 are evenly dispersed to promote a uniform fuel flow into an interior portion 43 of the fuel nozzle base assembly 26. The orifice plate 36 acts as a flow conditioner between entry of the fuel 22 into the fuel nozzle base assembly 26. One or more openings 44 are defined by an end portion of the fuel nozzle base assembly 26 to allow the fuel 22 to pass from the orifice plate 36 to the interior portion 43 of the fuel nozzle base assembly 26, while providing mechanical support and a structure for attaching the orifice plate 36.

In the illustrated embodiment, a single orifice plate is shown, however, alternative embodiments include a plurality of orifice plates disposed adjacent to each other to circumferentially form a 360 degree orifice plate assembly. Alternatively, as in the case of a fuel nozzle base assembly 26 without a central cartridge, the orifice plate 36 may be circular instead of an annular disc.

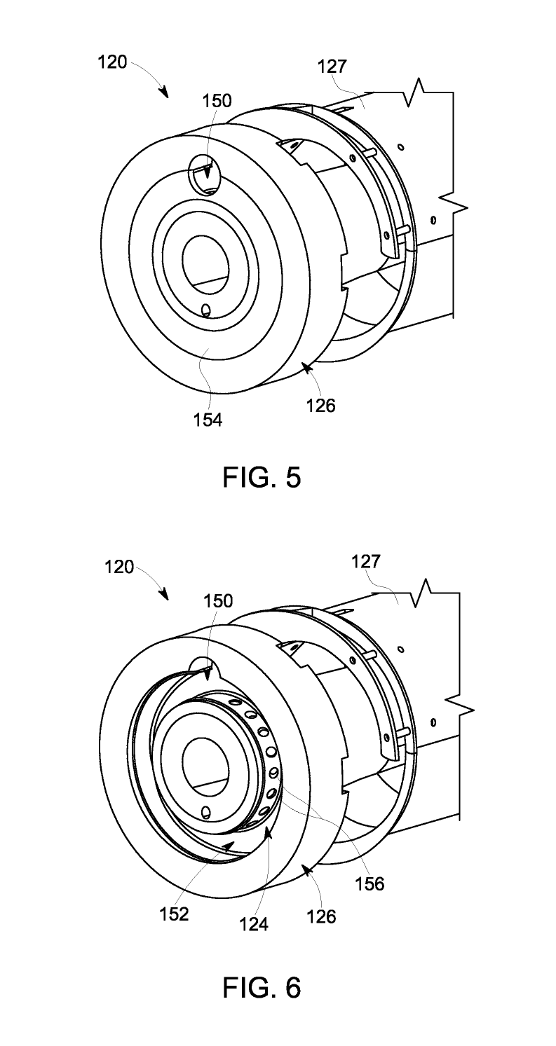

Referring now to FIGS. 5-7, a fuel supply system 120 (also referred to herein as a fuel nozzle assembly) configured to route the fuel 22 to the combustion assembly 14 is illustrated in greater detail according to another embodiment of the invention. More specifically, an inlet region 124 of the fuel supply system 120 is depicted. As described above in connection with the first embodiment, the inlet region 124 generally refers to a region where the fuel 22 is introduced into a fuel nozzle base assembly 126 for routing to a downstream region (not illustrated) that is configured for mixing of the fuel 22 and the high pressure gas (e.g., compressed air).

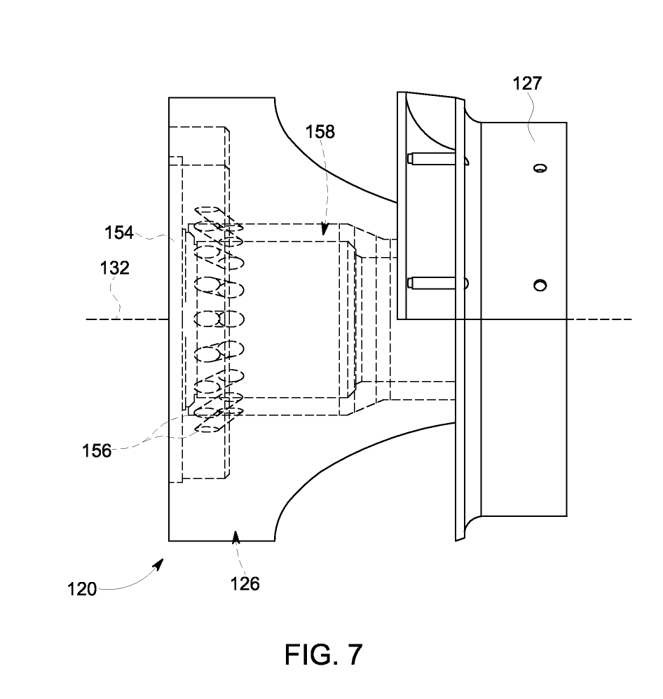

The fuel nozzle base assembly 126 is operatively coupled to an outer liner 127. The coupling may be made with mechanical fasteners, welding, or any other suitable joining method. The fuel nozzle base assembly 126 includes a main fuel inlet 150 in the form of an aperture or hole that fluidly couples a fuel supply (not shown) and a fuel manifold 152 partially defined within the fuel nozzle base assembly 126. As shown, the fuel nozzle base assembly 126 is oriented about an axis 132 (FIG. 7). The fuel manifold 152 extends circumferentially about the axis 132, typically 360 degrees about the axis 132. A cover plate 154 is secured to the fuel nozzle base assembly in a manner that axially contains fuel within the fuel manifold 152. In particular, the cover plate 154 is located to be in substantial alignment with the fuel manifold 152.

The main fuel inlet 150 may be completely defined by the fuel nozzle base assembly or may be defined by a combination of the fuel nozzle base assembly and the cover plate 154. Specifically, the fuel nozzle base assembly and/or the cover plate 154 may have an aperture portion that together forms the main fuel inlet 150, as illustrated. Alternatively, the main fuel inlet 150 may be completely defined by the cover plate 154. Irrespective of the precise configuration, the main fuel inlet 150 routes the fuel 22 to the fuel manifold 152.

The fuel nozzle base assembly 126 includes at least one, but typically a plurality of fuel passages 156 defined therein that is configured to route the fuel 22 from the fuel manifold 152 to a fuel annulus 158. In the illustrated embodiment, each of the plurality of fuel passages 156 are oriented at a non-parallel angle to that of the axis 132, however, it is contemplated that parallel arrangements may be employed. Additionally, the plurality of fuel passages 156 may be oriented at similar or distinct angles relative to the axis 132.

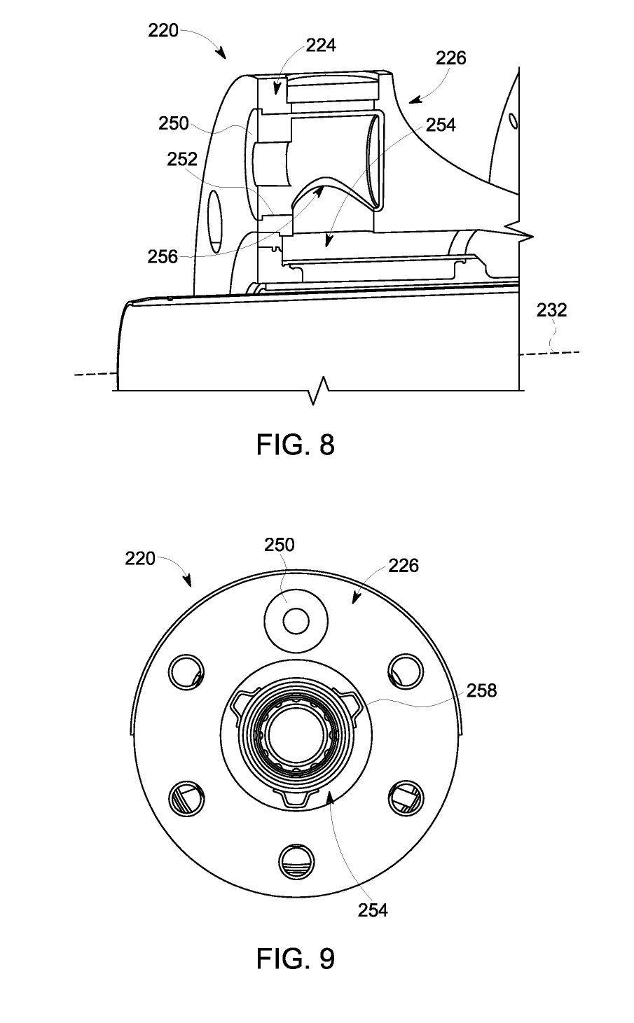

Referring to FIGS. 8 and 9, a fuel supply system 220 (also referred to herein as a fuel nozzle assembly) configured to route the fuel 22 to the combustion assembly 14 is illustrated in greater detail according to another embodiment of the invention. More specifically, an inlet region 224 of the fuel supply system 220 is depicted. As described above in connection with the above embodiments, the inlet region 224 generally refers to a region where the fuel 22 is introduced into a fuel nozzle base assembly 226 for routing to a downstream region (not illustrated) that is configured for mixing of the fuel 22 and the high pressure gas (e.g., compressed air).

In the illustrated embodiment, a pre-orifice structure 250 is secured within a main fuel inlet 252 that is defined by the fuel nozzle base assembly 226. The main fuel inlet 252 is a hole that extends relatively axially through the fuel nozzle base assembly 226. Secured within the main fuel inlet 252 is the pre-orifice structure 250 that includes an orifice configured to impart a pressure drop proximate the inlet region 224. The pre-orifice structure 250 may be secured within the main fuel inlet 252 in any suitable manner, including press-fitting or welding, for example. The fuel 22 flows through the pre-orifice structure 250 to a fuel annulus 254 defined within the fuel nozzle base assembly 226. As shown, the fuel nozzle base assembly 226 is oriented about an axis 232 that the fuel nozzle base assembly and the fuel annulus 254 are co-axially oriented about. The fuel annulus 254 extends circumferentially about the axis 232, typically 360 degrees about the axis 232. Upon entering the fuel annulus 254, the fuel 22 is subjected to an abrupt turn 256 to facilitate breaking up high velocity jets proximate the pre-orifice structure 250.

Disposed within the fuel annulus 254 is at least one, but typically a plurality of flow manipulation components 258 circumferentially spaced from each other. The plurality of flow manipulation components 258 may be formed in any geometric configuration that facilitates desirable conditioning of the flow of fuel within the fuel annulus 254.

Advantageously, the embodiments of the fuel nozzle assembly described herein provide more uniform flow of fuel at an inlet region of a fuel nozzle base assembly. By improving the fuel flow uniformity, overall efficiency of the combustions system is achieved. Furthermore, certain embodiments described herein make more efficient use of allocated space and overcome spatial constraints imposed on the overall fuel nozzle assembly.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle assembly comprising:
an end cover configured to receive a fuel;
a fuel channel defined by the end cover and configured to route the fuel through a portion of the end cover;
a fuel nozzle base assembly having a fuel nozzle inlet region, the fuel nozzle base assembly being located adjacent to, and operatively coupled to, the end cover;
an orifice plate disposed between the end cover and the fuel nozzle base assembly, the orifice plate having a plurality of apertures extending therethrough; and
an annular fuel plenum at least partially defined by the end cover and the orifice plate.

2. The fuel nozzle assembly of claim 1, wherein the end cover, the fuel nozzle base assembly and the orifice plate are co-axially oriented about an axis, wherein the annular fuel plenum extends circumferentially about the axis.

3. The fuel nozzle assembly of claim 2, wherein the annular fuel plenum extends 360 degrees about the axis.

4. The fuel nozzle assembly of claim 2, wherein the fuel channel is angularly oriented relative to the axis.

5. The fuel nozzle assembly of claim 1, further comprising a plurality of fuel channels configured to route the fuel through the end cover to the annular fuel plenum.

6. The fuel nozzle assembly of claim 1, wherein the orifice plate is operatively coupled to the fuel nozzle inlet region of the fuel nozzle base assembly by at least one of welding, brazing, and mechanically fastening.

7. The fuel nozzle assembly of claim 6, wherein the fuel nozzle inlet region comprises a plurality of openings configured to allow the fuel to pass from the orifice plate to an interior portion of the fuel nozzle base assembly.

8. The fuel nozzle assembly of claim 2, wherein the orifice plate extends 360 degrees about the axis.

9. The fuel nozzle assembly of claim 1, further comprising a plurality of orifice plates located circumferentially adjacent to each other to form a 360 degree orifice plate assembly.

10. A fuel nozzle assembly comprising:
a fuel nozzle base assembly having a main fuel inlet;
a fuel manifold at least partially defined by the fuel nozzle base assembly, the fuel manifold configured to receive a fuel provided through the main fuel inlet; and
a plurality of fuel passages circumferentially spaced from each other and extending from the fuel manifold to a fuel annulus.

11. The fuel nozzle assembly of claim 10, further comprising a cover plate operatively coupled to the fuel nozzle base assembly.

12. The fuel nozzle assembly of claim 11, wherein the fuel manifold is defined by the cover plate and the fuel nozzle base assembly.

13. The fuel nozzle assembly of claim 11, wherein the main fuel inlet comprises a hole defined by the cover plate and the fuel nozzle base assembly.

14. The fuel nozzle assembly of claim 11, wherein the fuel nozzle base assembly is oriented about an axis, wherein each of the plurality of fuel passages are angularly oriented relative to the axis.

15. The fuel nozzle assembly of claim 14, wherein the fuel manifold extends 360 degrees about the axis.

16. A fuel nozzle assembly comprising:
a fuel nozzle base assembly configured to receive a fuel therein;
an fuel annulus defined at an upstream end of the fuel nozzle base assembly; and
a pre-orifice structure directly coupled to the fuel nozzle base assembly and configured to route the fuel to the fuel annulus therein.

17. The fuel nozzle assembly of claim 16, wherein the fuel nozzle base assembly and the fuel annulus are co-axially oriented about an axis, the fuel annulus extending 360 degrees about the axis.

18. The fuel nozzle assembly of claim 16, further comprising a flow manipulation component disposed within the fuel annulus, the flow manipulation component configured to alter at least one flow characteristic of the fuel flowing through the fuel annulus.

19. The fuel nozzle assembly of claim 18, further comprising a plurality of flow manipulation components circumferentially spaced from each other.

20. The fuel nozzle assembly of claim 16, wherein the pre-orifice structure is operatively coupled to the fuel nozzle base assembly by at least one of welding, brazing, mechanically fastening, and press fitting.
